(19) United States
(12) Patent Application Publication
(10) Pub. No.: US 2017/0017925 A1
(43) Pub. Date: Jan. 19, 2017

(54) METHOD AND SYSTEM OF POSTING AND COLLABORATING BY LOCATION, AND CONTEXT BASED CONTENT IN AN ONLINE ENVIRONMENT

(71) Applicant: YOGESH CHANDRA SRIVASTAVA, CALGARY (CA)

(72) Inventor: YOGESH CHANDRA SRIVASTAVA, CALGARY (CA)

(21) Appl. No.: 15/212,872

(22) Filed: Jul. 18, 2016

Related U.S. Application Data
(60) Provisional application No. 62/194,231, filed on Jul. 18, 2015.

(51) Int. Cl. G06Q 10/10; G06F 17/22

(52) U.S. Cl. CPC G06Q 10/103; G06F 17/2241; G06F 17/2235

(57) ABSTRACT

A method is provided that includes: receiving information for a posting from a user associated with a local location and a regional location, the posting information including a location context; creating a posting, using the posting information; and making the posting viewable by members that have a location context that matches the location context determined for the posting. The method can include allowing other members to respond to the posting of the user if the other members match the location context determined for the posting. The method can also include making a connection between one of the members and the user and notifying the member of the posting by the user. The method can also include notifying a moderator of the posting and only making the posting viewable by members that have a location context that matches the location context determined for the posting if the moderator approves the posting.

### REFERENCE OF PROVISIONAL APPLICATION

In accordance with 35 U.S.C. 119(e), the corresponding provisional application is application No. 62/194,231 filed on date Jul. 18, 2015 with confirmation no. 6617.

This invention is in the field of information retrieval systems and in particular systems and methods providing location and 3 dimensional context of time, type of content and information category associated with content and retrieving content based on its location. The invention enhances the ability of people to collaborate amongst themselves as a society, with businesses, and with government to improve the social welfare, security and deliver good governance through a common platform. In Project and Construction management environment, the system enhances the collaboration amongst stake holders and entities involved in delivering the project.

### BACKGROUND

Computer networks like the internet combined with social networking software have produced a whole new way of experiencing social interactions and sharing information among users of the social networking software. Website such as Facebook™, LinkedIn™, etc. are all examples of websites that use social networking software over computer networks to allow various users to connect and establish relationships online.

However, while current existing social networking sites typically allow users to communicate, share or collaborate on a content object, there is an overwhelming amount of data and other types of electronic communication that continues to grow at a dramatic rate. It is becoming increasingly difficult for a person to keep up with and suitably narrow down relevant content that a person is looking for or even interested in on these social networking websites. While a person is online on one of these sites looking for relevant content, he or she can spend a significant amount of time sifting through a large volume of irrelevant content before they find content they are interested in or is relevant to them. For a time sensitive person, it can be difficult to arrive at relevant subject matter in a reasonable amount of time and its time relevance when the content was posted leads to a poor online experience for purposeful interactions.

As a citizen living in a society, there are many issues that a person encounters in their day-to-day lives. Numerous applications and online services are fragmented. The ultimate goal is to be able to save time—but it is challenging in dealing with multiple entities and contacts. By simplifying the process, providing a single point of location based contact and content saves money and time as well as boosts the satisfaction of people along with productivity. A common platform that maps a society online (eSociety) enabling bi-directional communications and transparency can improve the people to people (P2P), people to business (P2B) and people to governance (P2G) engagement.

In the Project and Construction Management environment, the root of majority of the problems are related to poor communication, withholding information and lack of effective methods of collaboration across Work Break-down structures, organizational hierarchy, companies involved in execution of the project. A common platform for information sharing, bi-directional interactivity and collaboration can improve communications, productivity and effectiveness of individuals on the project.

### SUMMARY OF THE INVENTION

A method is provided that includes: receiving information for a posting from a user associated with a local location and a regional location, the posting information including a location context; creating a posting, using the posting information; and making the posting viewable by members that have a location context that matches the location context determined for the posting.

In a further aspect, the method includes allowing an other member to respond to the posting of the user if the other member is able to view the posting because the location context of the other member matches the location context determined for the posting.

In a further aspect, the method includes making a connection between one of the members and the user and if the member matches the location context of the posting, notifying the member that the posting has been made by the user.

In a further aspect, the method includes notifying a moderator of the posting and only making the posting viewable by members that have a location context that matches the location context determined for the posting if the moderator approves the posting.

In a further aspect, the method includes incorporating project Work Break-down structure as location based content in a Project and Construction Management environment to enable enhanced collaboration amongst the members by the commonality of the WBS.

### DESCRIPTION OF THE DRAWINGS

A preferred embodiment of the present invention is described below with reference to the accompanying drawings, in which:

FIG. 1 illustrates a data processing system that can be used to implement the described system and methods;

FIG. 2 illustrates a system diagram to implement the described methods;

FIG. 3 illustrates a logical diagram for user and posting records that can be used to store and retrieve information based on an location context;

FIG. 4 illustrates a flowchart of a method of accepting a new user and creating a new user record associated with the new member;

FIG. 5 illustrates a flowchart of a method of accepting a new member of the system when the new member is sponsored by an existing member of the system;

FIG. 6 illustrates a flowchart of a user creating a posting for other members to view;

FIG. 7 illustrates a method of displaying content in the form of postings to a user;

FIG. 8 illustrates a method of allowing other members to respond to a posting;

FIG. 9 illustrates a method of a member of the system to respond to a posting;

FIG. 10 illustrates a method of actively moderating content of posting for improper material; and

FIG. 11 illustrates a method of passively moderating content of a posting for improper material.

### DETAILED DESCRIPTION OF THE ILLUSTRATED EMBODIMENTS

A location based content sharing system is provided that offers its members the ability to communicate, collaborate and interact with other members of the location based network without having the need to connect with one another on an individual basis. The commonality of the member's current location specific settings with the posted content's location context makes the content sharable to all members who belong to the same location, region or the globe.

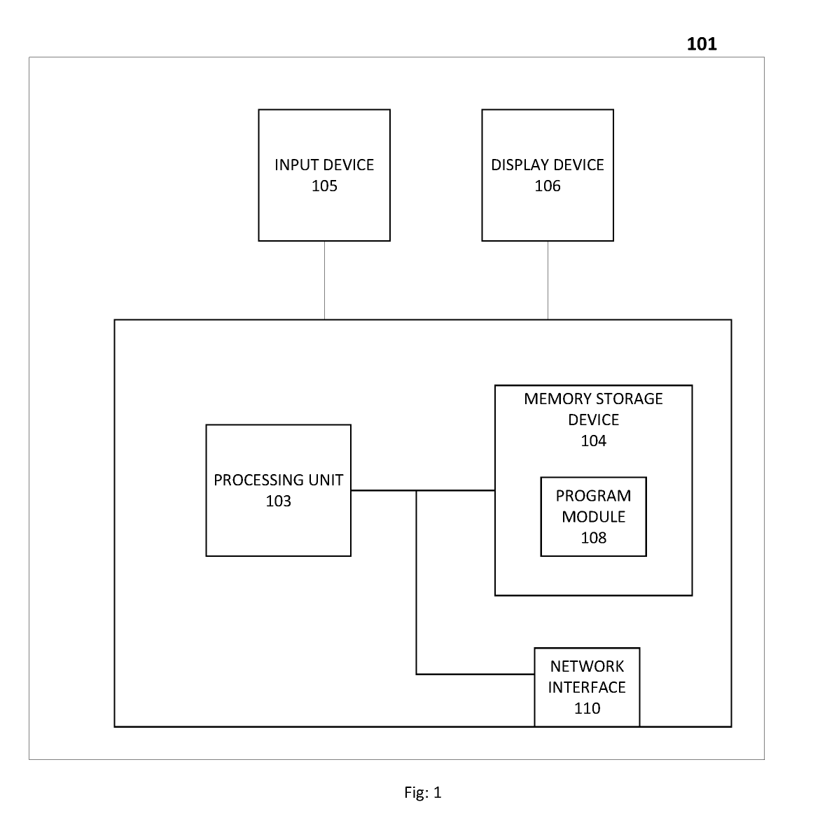

FIG. 1 illustrates a data processing system 101 suitable for supporting the operation of the described system and methods. The data processing system 101 could be a personal computer, workstation, server, mobile computing device, cell phone, smart phone, etc. The data processing system 101 typically comprises: at least one processing unit 103; a memory storage device 104; at least one input device 105; a display device 106; a program module 108 and a network interface 110.

The processing unit 103 can be any processor that is typically known in the art with the capacity to run the provided methods and is operatively coupled to the memory storage device 104 through a system bus. In some circumstances the data processing system 101 may contain more than one processing unit 103. The memory storage device 104 is operative to store data and can be any storage device that is known in the art, such as a local hard-disk, etc. and can include local memory employed during actual execution of the program code, bulk storage, and cache memories for providing temporary storage. Additionally, the memory storage device 104 can be a database that is external to the data processing system 101 but operatively coupled to the data processing system 101. The input device 105 can be any suitable device suitable for inputting data into the data processing system 101, such as a keyboard, mouse or data port such as a network connection and is operatively coupled to the processing unit 103 and operative to allow the processing unit 103 to receive information from the input device 105. The display device 106 is a CRT, LCD monitor, etc. operatively coupled to the data processing system 101 and operative to display information. The display device 106 could be a stand-alone screen or if the data processing system 101 is a mobile device, the display device 106 could be integrated into a casing containing the processing unit 103 and the memory storage device 104. The program module 108 is stored in the memory storage device 104 and operative to provide instructions to processing unit 103 and the processing unit 103 is responsive to the instructions from the program module 108.

The network interface 110 allows the data processing system 101 to be connected to a computer network such as an intranet or the internet. This network interface 110 could be an Ethernet card, modem or other line based network system or a wireless connection such as CDPD, Bluetooth, 802.11, or other suitable network.

Although other internal components of the data processing system 101 are not illustrated, it will be understood by those of ordinary skill in the art that only the components of the data processing system 101 necessary for an understanding of the present invention are illustrated and that many more components and interconnections between them are well known and can be used.

Additionally, the invention can take the form of a computer readable medium having recorded thereon statements and instructions for execution by a data processing system 101. For the purposes of this description, a computer readable medium can be any apparatus that can contain, store, communicate, propagate, or transport the program for use by or in connection with the instruction execution system, apparatus, or device.

Data processing system 101 typically runs a browsing application, such as Microsoft's Internet Explorer™, Mozilla Firefox™, Apple Safari™, Google Chrome™ or other browser program.

### System

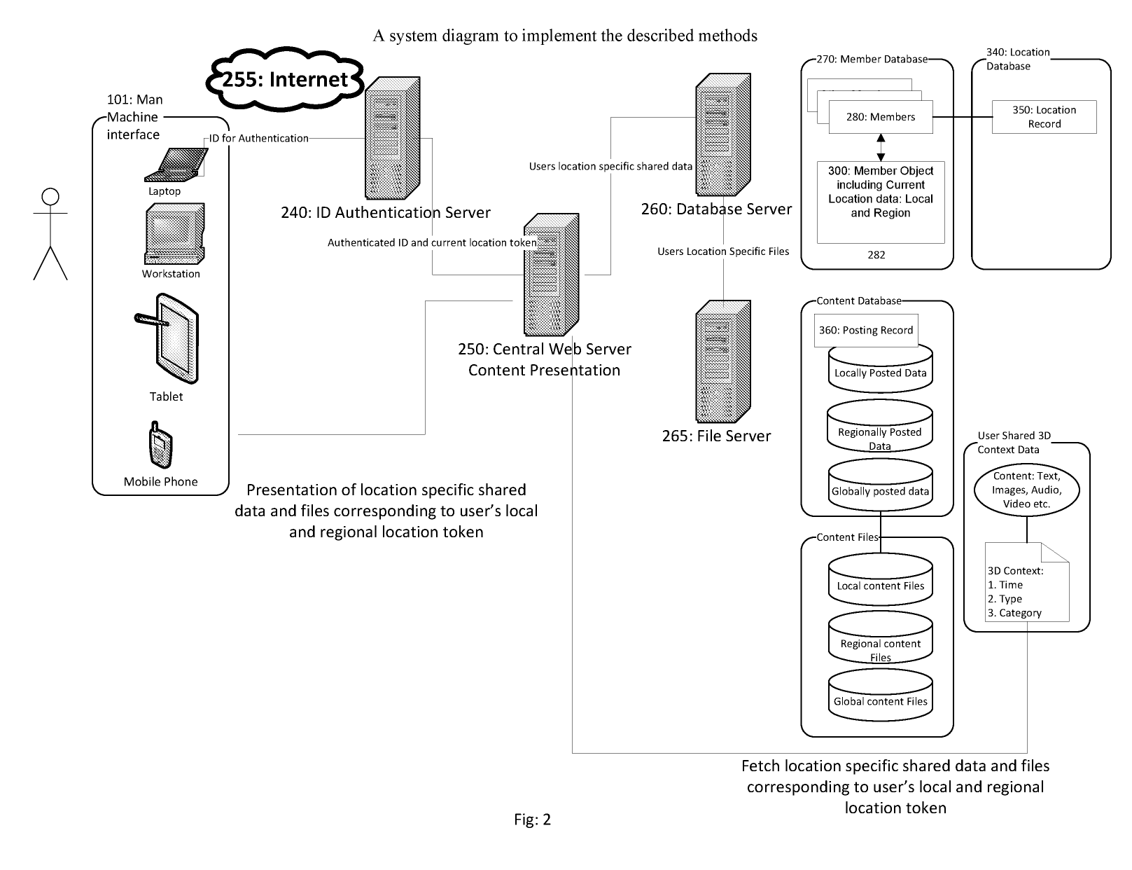

FIG. 2 illustrates a network configuration wherein the data processing system 101 is connected over a network 255 to central web server 250 running location based collaboration software. The network 255 can comprise a single network such as the internet or it could comprise a plurality of networks such as a wireless network, a wired network, etc. While in one aspect, the system is suitable for use with the Internet, it should be understood that the network 255 could comprise other types of networks, such as an intranet or other suitable network.

A user can be connected to the central web server 250 using a data processing system 101 through an authentication server 240. The authentication server 240 can validate the identity of the user and obtain the user's current location specific data and age band.

The central web server 250 can be operatively connected to a database 260 for storing data for the location based collaboration software. This data can include member records 280 stored in a member database 270, location records 350, posting records 360 and response records 390. The database 260 can be operatively connected to a file server 265 to store file attachments such as image files, video files, audio files, etc.

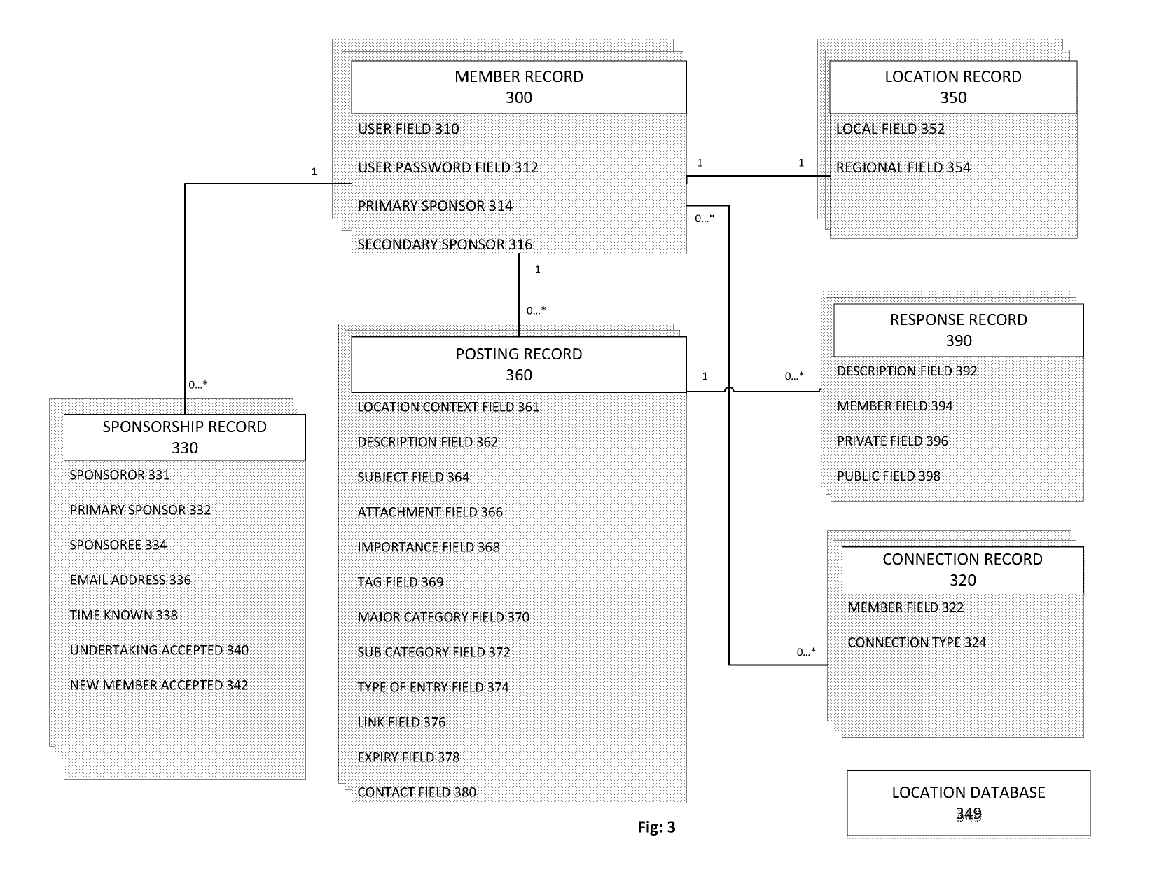

Each user in the set of members will have a member record 280 associated with him or her and stored in the member database 270. Each user record 280 can be associated with a location record 350 indicating location information associated with the user. Additionally, each posting made by a user can be stored as a posting record 360 and associated with one or more response records 390 containing responses to the posting. In one aspect, member records 280, location records 350, posting records 360 and response records 390 can be in the format of a member record 300 as shown in FIG. 3.

Each member record 300 corresponds with one of the members in a member set that uses the system and is the record used by the user as they are accessing the central server 260. Each member record 300 can include a user field 310 that contains an identifier (i.e. the name or a user name of the user) which identifies the specific user that corresponds to the user object 300 and a user password field 312 that contains the password of the user.

In addition, to storing some general information about the user, each member record 300 can be associated with a single location record 350. The location record 350 can include a local field 352 for storing an identifier of a city or township where the user is located and a regional field 354 for storing an identifier of a state or country where the user is located.

In one aspect, a location database 349 can be used to store a list of city or townships for the local field 352 and a list of states or countries for the regional field 354 of each location object 350.

In another aspect, the location information stored in the location record 350 could be a location of the member specified by means other than a city and a state or country. In one aspect, the location information could be related to construction projects and based on the project and sub-project the member is assigned to. For example, the system could be set up for a construction company that has a number of large projects being worked on at any given time. Employees or people contracted by the construction company would then work on one of the multiple projects that the construction company is working on. Additionally, each project, if large enough, might also be broken down into units of the projects (i.e. sub-projects on each project) and even further into specific geographical areas of the project. The location information stored in the location record could then use the local field 352 to store a specific area of a project site a member is working on an the regional field 354 to store a unit of a construction project the member is working on. The global location could then be the specific project that the member is assigned to.

For example, one member might work on a project that is to construct an oil refinery. However, they are assigned to unit 2 of the oil refinery project (which might be constructing the coker). Furthermore, they might be assigned to the eastern portion of the unit 2 of this project. The member's location record 350 could therefore indicate their location context by indicating the area (the eastern portion) in the local field 352, the unit (unit 30) in the regional field 354 and indicate the oil refinery—phase 2 as the global location.

A number of posting records 360 can also be stored with each posting record 360 associated with one of the member records 300 of the user who created and posted the posting. Each posting created and associated with a user can be associated with that user's member record 300 so that each posting record 360 can be associated with only one member record 300, but each member record 300 can be associated with a number of different posting records 360 (one posting record for each posting created and posted by the member).

Each posting record 360 can include a number of fields including: a description field 362 for storing the text of the posting; a subject field 364 for the storing subject line of the posting; an attachment field 366 for providing a link to any attachments that are part of the posting; an importance field 368 for storing an indicator of the importance of the posting; and a tag field 369 for storing text tags that can be used when other members are searching the various postings in the system. A link field 376 can be used to store any links that form part of the posting. Each posting record 360 could contain a number of other fields that are desired for implementing the system.

In addition to these fields, to implement the three dimensional aspect of the content i.e. Category, Type and Time in the system to enhance contextual content presentation for the User; each posting record 360 can contain the following three fields that are required for implementing the system. A major category field 370 which could be used to contain a main category that the posting will be posted in. If the system is set up to group postings by different major categories that map the societal needs of an individual to an online environment, i.e. Living space, Marketplace, Lifestyle & Entertainment, Needs & Benefits, Town Hall, Businesses & Groups, the major field category 370 could store the major category the posting record 360 is to be displayed in. A sub-category field 372 can be used to store a sub-category in the major category the posting record 360 will be displayed in. A type of entry field 374 can be used to store the type of entry the posting is. Examples of types of entries could be Thought, Information, Positive and Negative Experience, Buying, Selling, Lease/Rent, Record, Other, etc. An expiry field 378 can be included to store a date or time when the posting will expire so it does not stay on the system indefinitely.

In one aspect, the posting record 360 can contain a contact field 380. This contact field 380 can be used to store a list of members that should be notified of the posting. This could be in the form of links to various member records 300 that the user creating the posting would like to be notified of the posting being made. Alternatively, it could be a list of email addresses, etc. that allow other members or people to be notified that the posting has been made.

In addition to the various field contained in the posting record 360, there can be a location context field 361 for storing an indicator of whether the posting is contextually relevant to people either locally, regionally or globally.

Because other members will typically be able to respond to a posting, each posting record 360 can be associated with one or more response records 390 where each response record 390 corresponds to a response made by a user to the initial posting. Each response record 390 can include a description field 392 for storing the text of the response and a member field 394 containing an indicator of the user who posted the response. Additionally, the response record 390 can include a private field 396 and a public field 398 to indicate whether or not the response should be made public or private.

Members may make direct connections with other members of the system by requesting the other member add them as a connection. If the member accepts the connection, then a connection record 320 can be created for this connection. The connection record 320 can have a member field 322 for indicating the member that has made the connection and a connection type field 324 that can store the type of connection that exists between the members, i.e. Friends, Relatives, Co-Workers, etc.

For a new user to join and use the system, he or she will have to enter information about themselves. This information will then be used to create a member record 300 associated with this person which will then be stored in the member database 270. This information will include the location information of the user; where he/she is residing or other location information that is to be used by the system. This information can be maintained and updated administratively throughout the lifecycle of the user's membership within the system.

In further aspects, members of the system can or may have to be sponsored by an existing member of the system. Each member record 300 can further include a primary sponsor field 314 that can contains an identifier or another member that has sponsored the member that is associated with the member record 310. The member record 300 can also include a secondary sponsor field 316 that can contain an identifier of another member of the system that sponsored the primary sponsor (i.e. the member of the system that sponsored the member that is sponsoring the member associated with the current member record 300).

A number of sponsorship records 330 can also be provided that store information about the sponsorship of new members by existing members. The sponsorship records 330 can store information about a sponsorship of a new member by an existing member. The sponsorship record 330 can include a sponsor field 331 containing an identifier of the existing member that is providing the sponsorship and a primary sponsor field 332 that can contain an identifier of the member that sponsored the member who is now sponsoring a new member (this field can be used to determine the secondary sponsor for the new member being sponsored). A sponsoree field 334 can contain an identifier of the new member that is being sponsored by the existing member and an email address field 336 can contain an email address for the new member that is being sponsored. Because in one aspect, the member sponsoring the new member can give an undertaking that not only do they personally known the new member, but also how long they have known the new member, each sponsorship record 330 can contain a time known field 338 that contains the time (e.g. years, months, weeks, etc.) that the member sponsoring the new member has known the new member. Additionally, an undertaking acceptance field 340 can be included to store a value indicating whether or not the undertaking of the member sponsoring the new member has been accepted by the system. Finally, the sponsorship record 330 can include a new member accepted field 342 that indicates whether or not the member has successfully joined the system or not.

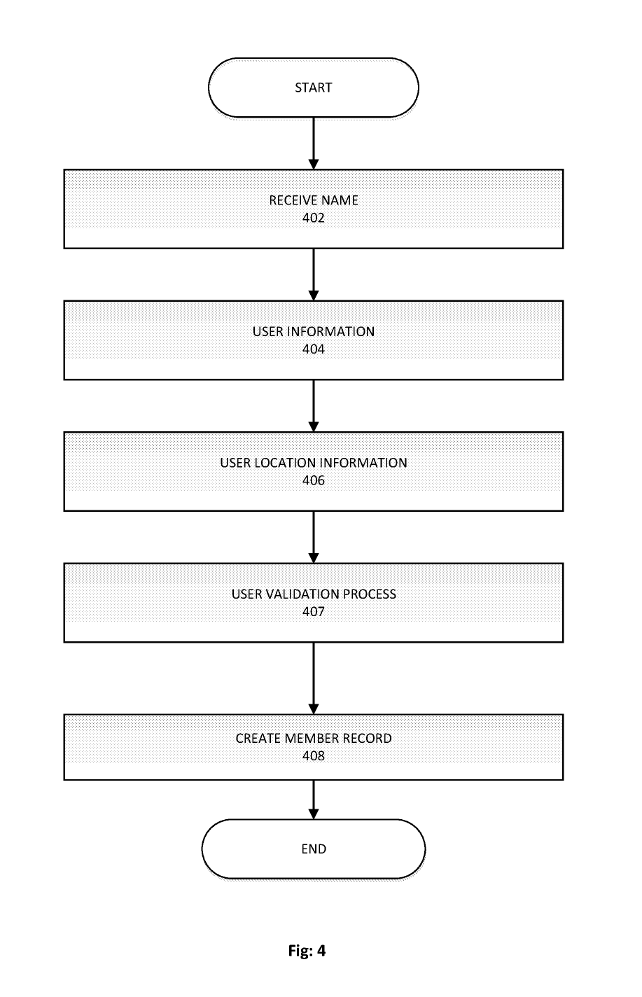

FIG. 4 illustrates a flowchart of a method for a new user to sign up for the location based collaboration software used in the system and create a new member record 300 associated with the new member.

The method starts and at step 402 a user can apply to become a new member of the system by filling out an application form, including provided his or her name at step 402. The name of the new user can be received by the central server 260. Typically, the new user will enter his or her name at step 402 and pertinent information at step 404 into a webpage form provided by the central server 260 and submit this information. Typically, a user name and password can be generated and the user name and password checked to see if there are any members using that user name already.

At step 404 information about the user can be received by the authentication server 240. This information can be any other information that might be desirable to know about a member.

At step 406, the user will be asked to specify their current location. This can be first the user's regional location (country/state) and secondly the user's local location (city/township/postal code group). Alternatively, it could be other location information if a different set of location information is being used. In one aspect, the local location and the regional location can be supplied to the user using the location database 349. The user can be presented with a drop down list on a website and the user can then select his or her local location and regional location from the drop down list to ensure incorrectly entered names or odd names of places are not entered, preventing the system from working correctly.

Optionally, at step 407 the method can validate the user. The new user can be manually validated by having someone attempt to confirm the new user is a real person and not an alias or another person trying to set up a fake account. This validation could include obtaining some identification from the new user (like a driver's license or other government identification). Alternatively, it could include someone placing a telephone call to the new user to ask them questions or get them to confirm, mailing a request to confirm to them, etc.

The method can move onto step 408 and a new member record 300 can be created using the information obtained in steps 402, 404 and 406. The user name and password can be administratively generated by the system during this step and can be used to populate the user field 310 and the user password field 312, respectively. Any information obtained at step 404 can be used to populate any other fields.

A new location record 350 can also be created and associated with the new user record 300. The local field 352 of this new location record 350 can be populated with the user's local location and the regional field 354 can be populated with the user's regional location that was obtained at step 406.

With the new member record 300 and location record 350 created and associated with the new member, this member record 300 can now be used when the new user uses the system to create or read postings on the system. The location specific information of each user is maintained throughout the lifecycle of the user's membership in the system. Since the system is centered around location specificity as declared by each member, in one aspect, any arbitrary changes to the location of a user is not allowed in the system unless and administrative and approval process is followed.

### User Validation

In another aspect, a new member of the system can be introduced and sponsored by an existing member. The existing member can sponsor the new member through the system by providing an undertaking indicating that the existing member personally knows the new member thereby allowing the existing member to sponsor the new member for a specified amount of time.

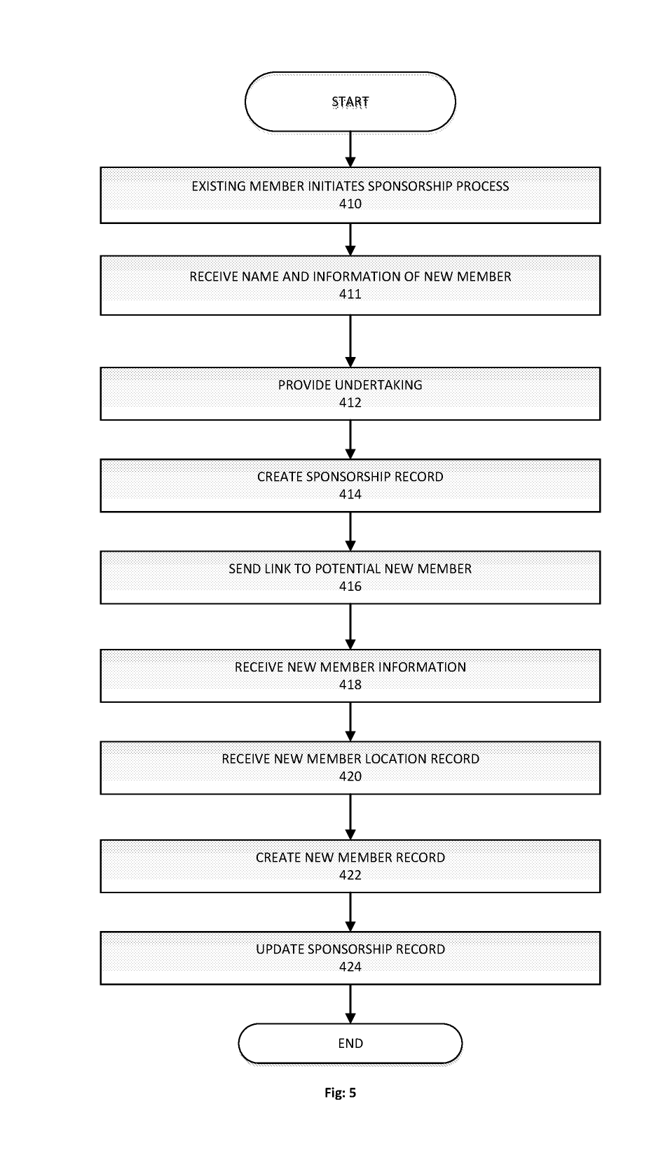

FIG. 5 illustrates a flowchart of a method of accepting a new member when the new member is being sponsored by an existing member of the system. The method can start at step 410 when an existing member initiates the sponsorship process and identifies another person that he or she is willing to sponsor. The method can then move onto step 411 and the system can receive the name and other information of this potential new member by the sponsoring exiting member. This information can include the new members can and email address that the potential new member can be contacted at. Additionally, any other information that may be desirable at this stage can be requested.

At step 412 the existing member can provide an undertaking that he or she personally knows the potential new member and optionally include the length of time that the existing member has known the potential new member

A new sponsorship record 330 can then be created at step 414 describing this new sponsorship of the potential new member. An identifier of the existing member that is sponsoring the new member can be stored in the sponsoror field 331 and the existing member's own primary sponsor (if they have been sponsored themselves) can be saved into the primary sponsor field 332 of this new sponsorship record 330. The email address for the potential new member provided at step 411 by the existing member can be inserted in the email address field 336 of the new sponsorship record 330 and the time the existing member has known the potential new member from the undertaking provided at step 412 can be provided in the time known field 338. If the undertaking provided at step 411 is accepted by the system, this can be indicated in the undertaking accepted field 340. Because it will not yet be known if the new member has successfully applied to be a member of the system and been accepted, the new member accepted field 342 can be left blank for the present time.

With a new sponsorship record 330 created, at step 416 a link can be emailed to the potential new member. The link can be a hyperlink and connect the potential new member to the system so that when the potential new member receives the email and clicks on the link, he or she will gain access to a sign up page on the system in order to sign up and become a new member that is sponsored by the existing member.

When the potential new member clicks on the link sent to them at step 416, the potential new member can access the system were they will be asked to provide information about themselves at step 418. This information can be any other information that might be desirable to know about a member including any information needed to create a member record 300 for the new member.

The new member will also be asked to specify their current location at step 420. This can be first, the new member's regional location (country/state) and secondly, the new member's local location (city/township/postal code group). In one aspect, the local location and the regional location can be supplied to the new member using the location database 349. The new member can be presented with a drop down list on a website and the new member can then select his or her local location and regional location from the drop down list to ensure incorrectly entered names or odd names of places are not entered, preventing the system from working correctly.

The method can move onto step 420 and a new member record 300 can be created using the information obtained in steps 414, 416 and 418. The user name and password can be administratively generated by the system during this step and can be used to populate the user field 310 and the user password field 312 of the new member record 300, respectively. Any information obtained at step 416 can be used to populate any other fields. An identifier of the existing member that is sponsoring the new member can be provided in the primary sponsor field 314 of this new member record 300 so it can be determined who the existing member is that has sponsored the new member and an identifier of the primary sponsor of the sponsoring existing member (i.e. the member who sponsored the existing member that is now sponsoring the current member) can be provided in the secondary sponsor field 316. In this way it can be recorded who sponsored the new member as well as who was the sponsor of the member who is sponsoring the current new member.

A new location record 350 can also be created and associated with the new member record 300. The local field 352 of this new location record 350 can be populated with the new member's local location and the regional field 354 can be populated with the new member's regional location that was obtained at step 418.

With the new member record 300 and location record 350 created, the method can move on to step 424 and update the sponsorship record created at step 414 by setting the new member accepted field 342 to true to indicate that the new member has now been accepted as a member of the system.

With the new member record 300, location record 350 and sponsorship record 330 created, the method can end.

### User Posting Method

Once a person is a user of the system and a member record 300 has been created for him or her, the user can make postings on the system that are viewable by other members. The user will also specify the location context of the posting (i.e. local, regional or global). This location context will determine which other members of the system will be able to view the posting based on the location context specified for the posting, the location of the user making the posting and the user who is viewing the various postings.

The postings can be simple text based messages by a user offering updates, offering things for sale or providing any information desired by the user making the posting. Postings can also be more complex; involving the inclusion of pictures or other files, links to websites, etc.

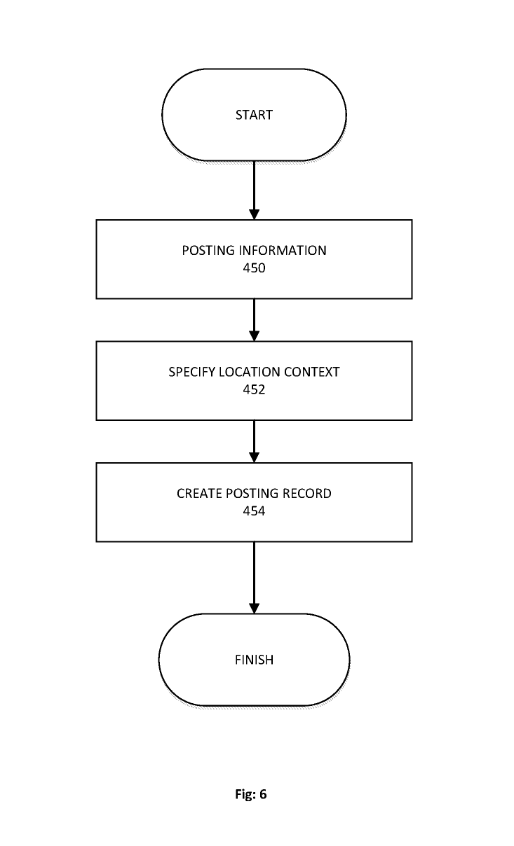

FIG. 6 illustrates a method of a user making a posting to the system. The method starts and at step 450, information for the posting can be received by the central server 260 by a user. This information would typically be entered by the user making the posting into a website and submitting it. This information would be the information the user wants to include in the posting including the text of the message the user wants in the posting. It can also include additional information that the user wants included in the posting including pictures or other files, links to websites, etc.

There might be a large number of postings on the system even if the postings are limited by location context. Therefore in one aspect, the postings could be further categorized. In one aspect, each posting record 360 could include a major category field 370 for storing a major category the posting will be associated with. This major category could be any categories deemed desirable such as: “Living space”, “Health”, etc. Each posting record could also include a sub-category field 372 that can hold a sub-category of the major category stored in the major category filed 370. Sub-categories could be any sub-category of a major category. For example, a major category such as “Living” can have sub categories “House, Utilities, Telecom, Security, Auto” etc.

When the user is submitting the post, he or she can be provided with the option to specify the type of posting they are making at step 450 and then this type of posting can be entered into the type of entry field 374 of the posting record 360. As an example for the type of entry; it may be a thought, information, record, positive experience, negative experience, buying, selling, leasing/renting, knowledge or other. While maintaining the location specificity, subject categorization and time relevance of the content; the attribute of type of entry can enhance the quality and relevancy of information being posted for other members of the system. Other users who qualify to view the post per the content display method described below can easily arrive to the type of content they are interested in by searching for the desired type of entry as a filter.

At step 452 the user can select the location context in which the posting should appear. This location context could be: local; regional or global. Which of these location contexts are specified, will determine which of the other members can view the posting. If a user selects global, all members in the system may be able to view the posting. However, if the user selects local, only those members with a local location that matches the local location of the user will be able to view the posting and if the user selects regional, only those users with a regional location that matches the regional location of the user will be able to view the posting.

At step 454 a posting record 360 can be created using the information obtained from the user at steps 450 and 452. The information for the posting entered by the user at step 452 can be used to complete the description field 362 and the posting record 362 can use the location context specified at step 452 to determine to which members the posting will to be displayed. The posting record 360 can be associated with the user record 300 corresponding to the user who created the posting and the location record 350 associated with the user record 300 will be inherited by the posting record 360 to obtain the location of the user who made the posting for the posting record.

### Content Display Method

When a user is looking at the postings, the postings that are displayed to a particular user will be based on the location of the user who made the posting and the location context specified for the posting by the user.

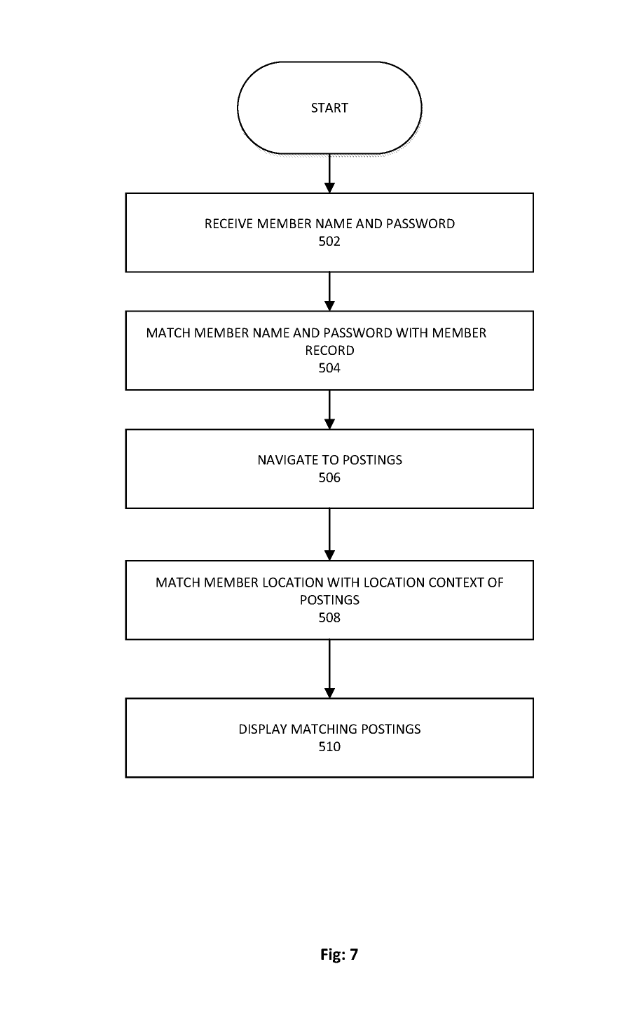

FIG. 7 illustrates a method of displaying content in the form of postings made by other members where the viewable postings are based on the location of the user who made the posting, the user viewing the posting and the location context set for the posting. The method can start and at step 502 a user name and a user password can be received from a user logging into the system. This user name and user password can be matched with a member record 300 corresponding to the user logging into the system at step 504 and the corresponding member record 300 can be retrieved. By retrieving the member record 300, the location record 350 associated with the member record 300 can also be obtained. In this manner, the system will have the local location and the regional location of the user that has logged in at step 502.

At step 506 the user can navigate to the postings of interest. Because there can be a large number of postings, it may be desirable to limit the number of postings the user is viewing even beyond matching it to a location context. If each posting is further categorized by a major category and a sub-category, at step 506 the major category and the sub-category can be selected and the system can prepare to display the relevant postings by location context in the selected major category and the sub-category.

At step 508 the system can determine which postings to display to the member. The system can use the location object 350 of the user and the local location and regional location in the local field 352 and the regional field 354 and match these locations with the location context in the location context field 361 of each posting object 360 and then the applicable local location or regional location of the user who made the posting.

At step 510 the relevant postings can be displayed to the member.

For example: if Jack and Shane are both members of the system who have both specified their current location as Calgary (Local location), Alberta, Canada (Regional location), they will see each other's content posted locally, regionally and globally; another user of the system Lee whose current location is Toronto (i.e. a different Local location), Ontario, Canada (Same Regional location) is allowed to have limited or no interaction for the local (Calgary) content as he does not belong to that location. However, he can view and interact with content that they post as ‘Regional’ (i.e. Canada wide) and also for the global content since the “Regional’ context for Jack, Shane and Lee is the same.

The above example is further elaborated with the application of Major and Minor categories interacting with the location based content display as follows. In one example, Jack is currently residing in Calgary, Alberta, Canada, Shane is currently residing in Calgary, Alberta, Canada, Lee is currently residing in Toronto, Ontario, Canada and Ram is currently residing in Mumbai, Maharashtra, India. As an example, if Jack creates a post about his holiday experience skiing in Banff with pictures and he selects the location context of the posting to be “local”, Shane who is also from Calgary can also view this posting even though Jack and Shane may not have made a direct connection with one another in the system. In the above example, Lee and Ram do not share the same “local” location as Jack and therefore cannot see this posting.

In another example, if Jack indicated that the location context of a posting is “regional”, Shane as well as Lee can see the posting without any of them being a direct connection with Jack because they all belong to the same region (Canada). However, Ram would not be able to see the posting as his regional location differs from Jack, Shane and Lee because he is not from Canada.

In a further example, if Jack has selected to post the content globally by indicating that the location context is “global”, every user in the system can see this content because each user falls under the global category regardless of their actual location. In this case, Jack's posting can be seen by Shane, Lee and Ram.

Alternatively, if the system was related to Project and Construction management environment that is using the Work Break-down Structure (WBS) in the project dividing the scope as Project, Units and Areas as the location information associated with a member, then a member Jack might have local location of Construction Area 10 while his regional location is Unit 30 and his global location is Refinery project. Member Shane might have a local region of Construction Area 10, a regional location of Unit 30 and the same global location of Refinery project. Member Lee might have a local region of Construction Area 40, a regional location of Unit 30 and a global location of Refinery project. Finally, member Ram might have a local location of Construction Area 10, a regional location of Unit 50 and a global location of Refinery project.

If a posting is made by any of the members and the location context is set to global, then all the other members can view and collaborate on the posting. However, if Jack makes a posting and sets the location context to local, then only Shane and Ram can fully collaborate on the posting, while Lee that has a different local location (Construction Area 40 rather than 10) will have limited or no collaborative ability for the posting. If Jack makes a posting and specifies a regional location context, then Shane and Lee can see and collaborate on the posting because they share a regional location with Jack, but Ram, who has a different regional location than Jack, will have a limited or no ability to collaborate on that posting.

This method enables location based levels of interaction with content being specified during posting to appear locally, regionally or globally. By making it available to the members of the system who belong to the same Work Break-down Structure setup as locality or region, depending on the location context specified for the posting, enhances the relevance of the content being shared from the user's location point of view and their ability to collaborate on the subject matter. The subject matter as applied to that particular area while not required the different members of the system to have a direct connection to other members yet still provide relevant filtering of the postings based on the location of the user making the posting, the user viewing and collaborating on the posting.

### Responding

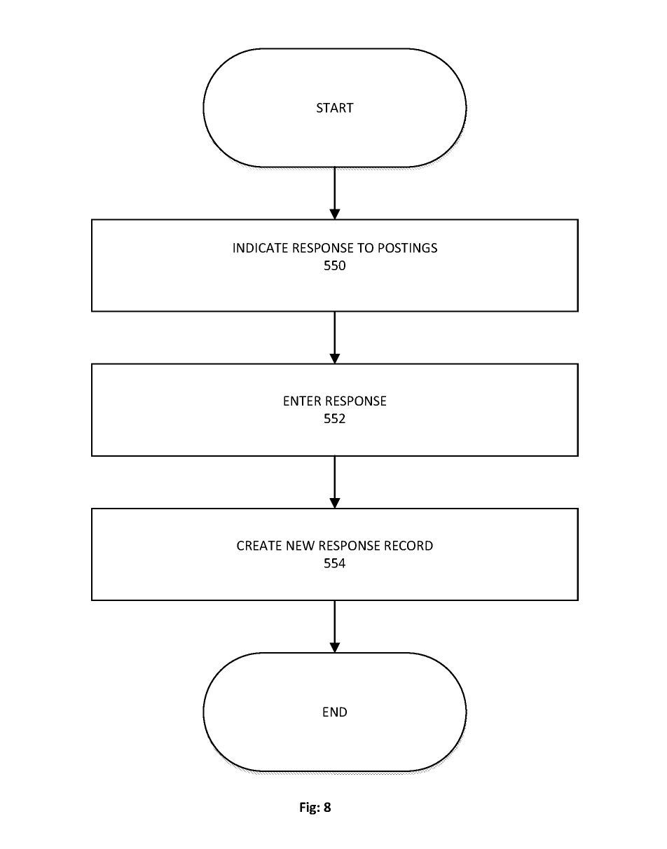

FIG. 8 illustrates a method for a member other than a user making the posting to provide a response to posting. Each posting as selected and displayed to members of the system could allow other users to respond to the posting and leave their own comments and feedback. Each response to a posting that is made in the system, such as a posting created using the method shown in FIG. 6, can be stored as a response record 390 and associated with the posting record 360 corresponding to the posting that the response is being made about.

At step 550 a user reading the posting, can indicate that he or she want so to respond to a posting he or she is viewing. For example, a user could click on “respond to this posting” so that the user can provide his or her comments and feedback to the posting. At step 552 a user can then enter the text they would like the response to contain, such as the comments he or she is making regarding the original posting, and any other information the user would like the response to contain. The user can also indicate whether or not he or she would like the response to be private. In one aspect, a user can select an appropriate radio button for the response to be made either public or private.

With the information obtained at step 552, a new response record 390 can then be created at step 554 and stored in the database 260. The information provided by the user can be used to populate the fields in the new response record 390. The text the user enters can be entered in the description field 392 of the new response record 390 and the private field 396 can be used to indicate that the response is to be private if that is what the user selected or the public field 398 can be used to indicate the response is to be made public, if the user has elected to have the response public. An identification of the user who made the response can be stored in the member field 394.

If the response is marked public, it can be displayed to all members of the system who are able to view the original posting because their location matches the location context specified for the posting. However, if the response is marked private, it can be displayed only to the user who made the original posting.

In this manner, members of the system are able to interact with one another either on a one on one basis with the original owner of the posting by posting a response marked private or interact with the general membership by marking a response public, thus enhancing the interactive experience.

### Notify Contacts

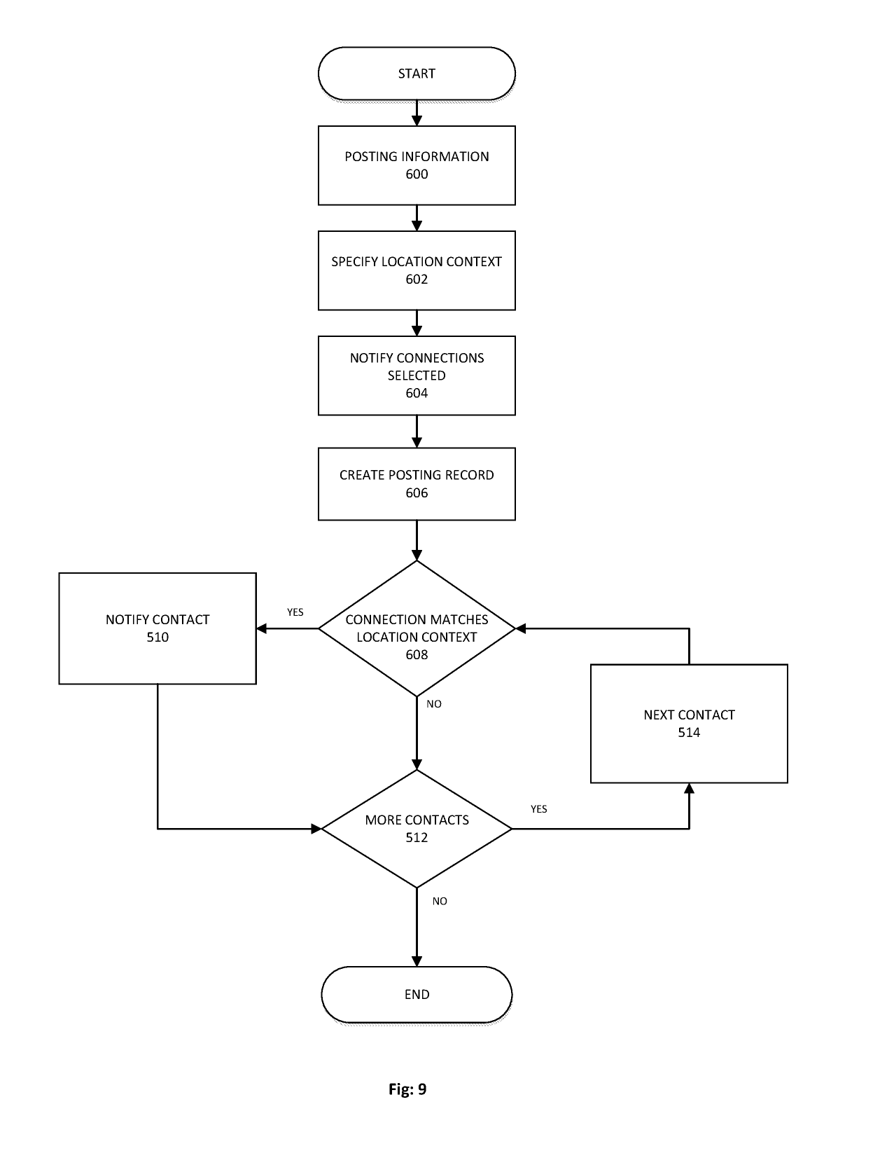

FIG. 9 illustrates a further method where a user can make a posting and other members of the system who have made a connection with the user making the posting are notified of the posting if the other member's location match the location of the user making the posting and the location context specified for the posting.

Members may make direct connections with other members of the system by requesting the other member add them as a connection. If two members have formed a connection, a connection record 320 can be created for this connection. The connection record 320 can have a member field 322 for indicating the member that has made the connection and a connection type field 324 that can store the type of connection that exists between the members, i.e. Friends, Relatives, Co-Workers, etc.

The method shown in FIG. 9 can begin similar to the method shown in FIG. 6, with a user posting information at step 600 and specifying location context for the posting at step 602. At step 600, information for the posting can be received by the central server 260 from the user. This information would typically be entered by the user making the posting into a website and submitting it. This information would be the information the user wants to include in the posting including the text of the message the user wants in the posting and any additional information that the user wants included in the posting including pictures or other files, links to websites, etc. At step 602 the user can select the location context in which the posting should appear. This location context could be: local; regional or global. Which of these location contexts are specified, will determine which of the other members can view the posting.

At step 604 the user can select that he or she wants to notify their connection in the connection field 380, i.e. the group of people that he or she is connected with. In a further aspect, the user can select a type of connection that he or she wants to be notified of the posting instead of just selecting all of the user's connections. For example, if possible connection types were Friends, Relatives, Co-Workers, a user could select that only connections that are Relatives will be notified of the posting at step 604.

A posting record 360 can then be created a step 606 using the information obtained from the user at steps 600, 602 and 604. The information for the posting entered by the user at step 600 can be used to complete the description field 362 of the posting record 360 and the location context specified at step 602 can be used to determine to which members the posting will to be displayed. The posting record 360 can be associated with the user record 300 corresponding to the user who created the posting and the location record 350 associated with the user record 300 will be inherited by the posting record 360 to obtain the location of the user who made the posting for the posting record. This location can be used in conjunction with the location context specified at step 602 to determine which members of the system can view the posting.

The connection field 380 of the posting record 360 can be populated with the members connected with the user. If the user has specified members who are connected and have a specific connection type, only the connections of this connection type can be used to populate the connection field 380.

At step 608 each member in the contact field 380 that the user who created the posting is connected to (and meets the connection type specified in step 604 if applicable) can be examined to determine if the location context of the member matches the location context specified for the posting at step 602 by the user and the relevant location of the user that made the posting. If the location context of the member matches the location context specified for the posting, then the method can move on to step 610 and notify the connection that the user has made a posting that he or she might be interested in viewing. For example, of a user selects global for the location context, all other members in the system with connections to the user (and optionally match the connection type) can be notified of the posting. However, if the user selects local, only those members connected with the user and that have a local location that matches the local location of the user will be notified of the posting and if the user selects regional, only those members connected to the user and that have a regional location that matches the regional location of the user will be notified of the posting.

The notification could also contain a link to the posting so that the other member can simply select the link to view the posting. The system can then move onto step 612 and check if there are more contacts to potentially notify of the new posting. In this manner, the method determines the location of a member that has a connection with the user making the posting and only notifies the member if he or she matches the location context in the location context field 361 of the posting record 360.

If however, at step 608 it is determined that the member does not match the location context specified in the location context field 361 of the posting record 360, then the method will move onto step 612 and check if there are more contacts. At step 612 the method will check to see if there are any more contacts specified in the contact field 380 of the posting record 360. If there are more contacts at step 612, the method will move to the next contact at step 614 and return to step 608 to see if the next contact matches the location context in the location context field 361 of the posting record 360. Steps 608, 610, 612 and 614 will be repeated as necessary until there are no more contacts specified in the contact field 380 of the posting record 360 at which time the method can end with all the appropriate connections to the user being notified of the posting.

The method can enhance the context of the content sharing significantly by providing notifications and direct access to the local content being posted by a user to members that are connected with the user and have the same local location, postings with regional content being posted by the user getting exposed to only those connections that are in the same region as the user making the posting and content that is posted in the global category having all of the contacts notified and shared directly with all of the user's connections.

For example, under this example, if Jack makes a one on one connection with Shane, Lee and Ram, they are automatically categorized based on their current location either as local (in the same city), regional (same country) or global (current location not in the same country):

### Jack's Connections:

| | | | | | Jack's | |
|---|---|---|---|---|---|---|
| | | | | | Connection | Jack's |
| | Individual | Local | Region | Global | type | Connection |
| 1 | Jack | Calgary | Canada | | Self | Self |
| 2 | Shane | Calgary | Canada | | Relation | Local |
| | | | | | | Connection |
| 3 | Tina | Toronto | Canada | | Relation | Regional |
| | | | | | | Connection |
| 4 | Lee | Toronto | Canada | | Friend | Regional |
| | | | | | | Connection |
| 5 | Ram | Mumbai | India | | Professional | Global |
| | | | | | | Connection |

When Jack posts a content specifying it to be posted locally and selects the option to share with his relations; Shane who is a contact as a ‘Relation’ but also belongs locally (in same city Calgary) gets notified about the posting made by Jack. However, Tina who also is a “Relation’ but not local to Jack does not get notified about this posting as she is not local to Jack's location.

This method delivers location based content with direct notification and access to members who are connected with the user making the posting who belong to that particular location as specified in the location context as well as any other members of the system that have the same location context and want to view the posting.

### Posting Expiry and Archiving

Each posting record 360 can include an expiry field 378. A posting made on the system can expire in a first period of time from the posting date. For example, the expiry date could be one week from the date the posting was created. When this expiry date has passed, the posting will no longer be viewable by members on the system.

In one aspect, the expiry date can be set for a second period of time from the date it was created where this second period of time is longer than the first period of time, if the user pays an extension fee.

Once a posting has reached its expiry date and is no longer viewable by the members of the system, the posting record 360 can be moved to the content space in the member database 280 of the user who made the posting and can be displayed to the user that made the posting under “expired postings” in the “My Content” tab.

### Location Based Moderation Method

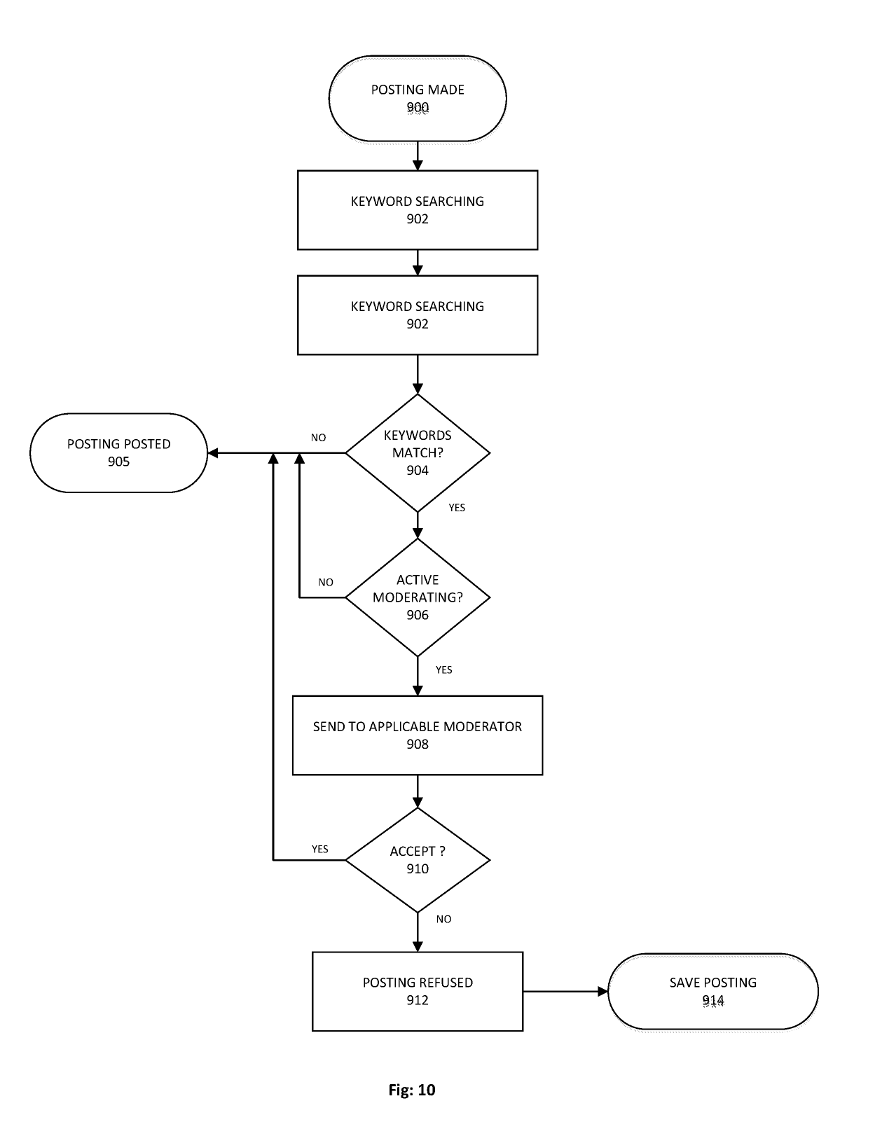

The usefulness of the content of the location based online network can be enhanced by a location based moderation process. Referring to FIG. 6, before the posting that has been created is posted on the site, the response can be monitored for any objectionable material or content. FIG. 10 illustrates a method of moderating postings to intervene if there is objectionable material or content in them. The method can start at step 900 when a posting is to be made. At step 902 the system can perform keyword searching on the text and contents of the posting. The description field 367 of the posting record 360 can be compared with a keyword filtering file 282 stored in the database server 260. The keyword filtering file 282 can contain a list of words and/or phrases that are objectionable.

At step 904 if no words in the description field 367 of the posting record 360 match any of the words in the keyword filtering file 282, meaning that no objectionable words have been found, then the system can move on to step 905, the posting can be made and the method can end. At this point members of the system will be free to view the posting (if the members meet the location context specified for the posting).

If, however, at step 904 a word in the description field 367 of the posting record 360 matches a word in the keyword filtering file 282, then the system can move onto step 906 and can check to see if active moderating is occurring. Active moderation means that there is currently a person assigned to the location context specified for the posting record 360 in the location context field 361. For example, there will be local moderators for different local locations, regional moderators for regional locations and one or more global moderators. After step 906, if there is active moderation, the system can move to step 908 and send the posting information to the applicable moderator based on the location context in the location context field 361. If the location context in the location context field 361 is specified to local, then the posting will be sent at step 908 to a local moderator for the local of the user who made the posting. If the location context in the location context field 361 is specified to regional, then the posting will be sent to a regional moderator for the Region associated with the user. If the location context in the location context field 361 is global, then the information for the posting can be sent to a global moderator at step 908.

If at step 906 it is determined that there is no active moderation, either it is not being used or that there is not a moderator assigned to the regional location or local location specified for the posting, the method can move to step 905, the posting can be posted and the method can end.

If the posting information is sent to the appropriate moderator at step 908, the moderator can view the posting to make a subjective determination of whether or not the posting is in any way objectionable and whether or not it should be posted or refused. In one aspect, the moderator can review the content of the posting for compliance with a user network policy and if in the moderator's opinion the posting is not in compliance with the policy (e.g. the moderator thinks it is obscene or offensive), the moderator can reject the posting. The moderator can indicate their decision that the posting either be accepted or denied at step 910. In one aspect, the moderator can complete a review notification form with reasons for the rejection and submit it to the system.

If the posting has not been accepted by the moderator at step 910, the method can move onto step 912 and the posting can be refused. If the moderator has submitted a review notification form with reasons for the refusal, the review notification form can be sent to the user that submitted the posting and optionally at step 914 the rejected posting record can be saved in a moderators record in the moderators page and saved in association with the members record 300 how made the posting in the removed posting area.

If at step 910 the appropriate moderator deems the content of the posting appropriate and accepts the posting, the system can move on to step 905, post the posting so that it is viewable to members of the system that match the location context and the method will end.

Instituting a location based moderation method when collaborating and sharing digital content in an online system, can improve the quality of data being shared by reducing undesirable content that makes its way through to the larger membership.

### Passive Moderation

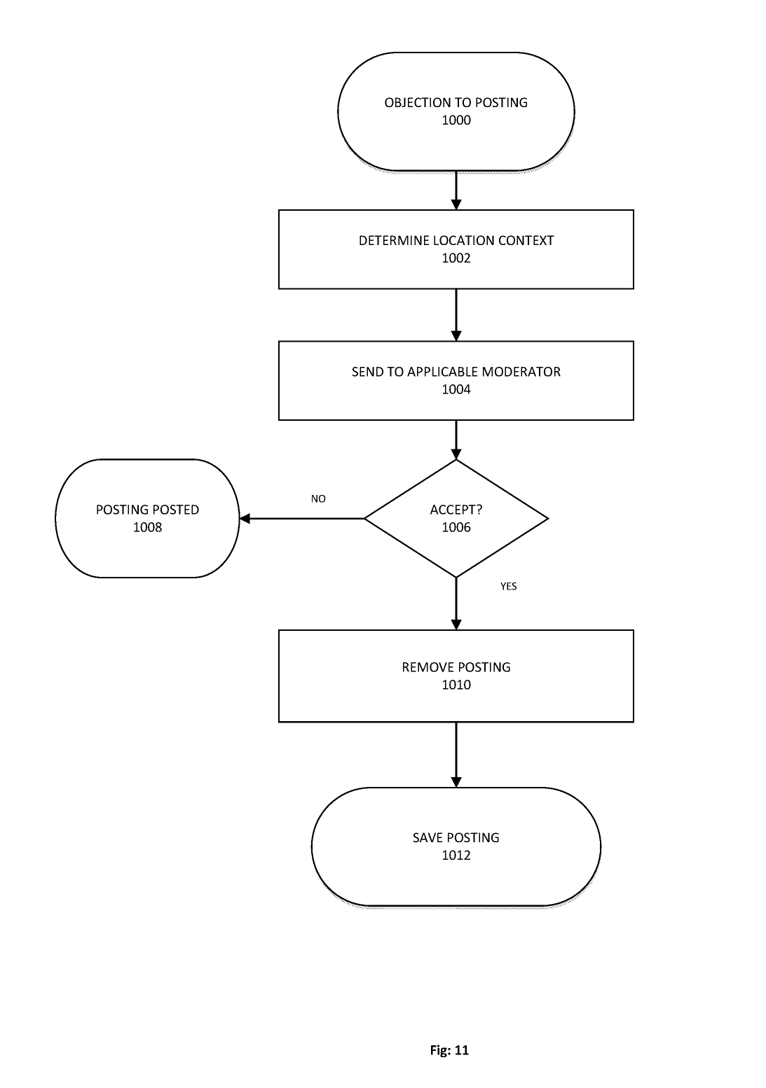

Even if the posting is completed at step 905 and the posting is now viewable by members of the system, steps can be provided that allow other members to object to a posting after it has been posted. FIG. 11 illustrates a method of passively moderating postings in the system by allowing other members to object to a posting.

The method can start at step 1000 when a member other than the member who made the posting objects to the posting. The member will typically make an objection and provide feedback as to why he or she feels the content of the posting is objectionable.

After the objection has been made, the method can move onto step 1002 and the system can determine the location context specified for the posting. This will be in the location context field 361 of the posting record 360. If the location context is local, the system will move onto step 1004 and the objection will be sent to a local moderator for a location that matches the local location of the user who made the posting. If the location context is regional, the system will move onto step 1004 and forward the objection to the posting to a regional moderator that matches the regional location of the user that submitted the posting. If the location context is global, the system will move onto step 1004 and forward the objection to an appropriate global moderator.

After the appropriate moderator has had a chance to review the objection and the contents of the posting, he or she can decide whether to accept the objection and remove the posting or to ignore the objection to the posting and leave the posting in place. At step 1006 the moderator can submit their decision regarding the posting.

If at step 1006 the moderator has decided to keep the posting and ignore the objection, the system can move onto step 1008 and keep the posting record 360 viewable to other members who match the location context specified for the posting. If however at step 1006 the moderator decides to accept the objection and remove the posting, the posting can be removed at step 1010. The moderator can fill out a review notification form that will be sent to the user that made the posting to inform the user of the reasons the posting was removed.

The system can then move onto step 1012 and the rejected posting record can be saved in the moderators record in the moderators page and saved in association with the members record 300 how made the posting in the removed posting area.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A method comprising:
receiving information for a posting from a user associated with a local location and a regional location, the posting information including a location context; creating a posting, using the posting information; and making the posting viewable, interactive and enable collaboration with members that have a location context that matches the location context determined for the posting; and limiting the interactivity and collaboration for those members whose location context does not match with that of the posting.

2. The method of claim 1 wherein the location context is one of: global, regional location and local location.

3. The method of claim 1 wherein the user and each member has a location context comprising a local location and a regional location.

4. The method of claim 3 wherein the local location is a city, township, or an area by postal code, or an area by postal code grouping and the regional location is a state, and a country.

5. The method of claim 4 wherein the local location is a city/township/postal code group the user lives in and the regional location is the state/country where user lives in.

6. The method of claim 1 wherein the posting is assigned at least one category.

7. The method in claim 6 where the categories include personal, business, societal, and governmental needs of an individual in a society as Living space, Marketplace, Lifestyle & Entertainment, Needs and Benefits, Town hall, Businesses & Groups.

8. The method of claim 7 wherein the posting is assigned a major category and a sub-category.

9. The method of claim 1 further comprising allowing an other member to respond to the posting of the user if the other member is able to view the posting because the location context of the other member matches the location context determined for the posting.

10. The method of claim 9 wherein the response is one of: a public response viewable by all other members that can view the posting; and a private response viewable only to the user that made the posting.

11. The method of claim 1 further comprising making a connection between one of the members and the user and if the member matches the location context of the posting, then the ability of notifying the member that the posting has been made by the user.

12. The method of claim 11 wherein the connection has a connection type and the user specifies the connection type and if the member matches the location context of the posting and the connection type, notifying the member that the posting has been made.

13. The method of claim 11 wherein the notification contains a link to the posting.

14. The method of claim 1 wherein the posting has an expiry date and the posting is removed at the expiry date.

15. The method of claim 14 wherein the posting has a second expiry date that is later than the expiry date and the posting is removed at the second expiry date if the user provides a fee.

16. The method of claim 1 further comprising: notifying a moderator of the posting and only making the posting viewable by members that have a location context that matches the location context determined for the posting if the moderator approves the posting.

17. The method of claim 16 wherein the moderator is one of: a local moderator; a regional moderator; and a global moderator, based on the location context of the posting, thereby establishing a distributed moderation method within the system for an online community block-watch.

18. The method of claim 16 further comprising: keyword filtering the posting for objectionable words and notifying moderator of the posting only if an objectionable work is found.

19. The method of claim 1 further comprising: in response to a member objecting to the posting, notifying a moderator a moderator of the posting and removing the posting if the moderator objects to the posting.

20. A method comprising of creating member accounts based on current location specified in the application by the user and grouping them in local and regional context.

21. The method in claim 20 where the account is a unique multipurpose global digital account enabling personal, business, societal and governmental interactions between people to people, people to business and people to government bi-directionally.

22. A method comprising of an existing member becoming a sponsorer and introducing another member taking accountability of knowing the individual by specifying the length of time known.

23. The method in claim 22 where the system keeps record of who has introduced whom in the system as a primary sponsor and maintaining traceability to the secondary sponsor.

24. A method comprising:
A Project and Construction Management environment receiving information for a posting from a user associated with a Work Break-down structure (WBS) based local location and a regional location, the posting information including a location context; creating a posting, using the posting information; and making the posting viewable, interactive and enable collaboration with members that have a location context that matches the location context determined for the posting; and limiting the interactivity and collaboration for those members whose location context of the Work Break-down Structure does not match with that of the posting.

25. The method of claim 24 wherein the location context is one of Work Break-down structure hierarchy: Project, Unit and Area location.

26. The method of claim 24 wherein the user and each member has a location context of the Work Break-down structure hierarchy: Project, Unit and Area location.
